(19) United States
(12) Patent Application Publication
(10) Pub. No.: US 2014/0067401 A1
(43) Pub. Date: Mar. 6, 2014

(54) PROVIDE SERVICES USING UNIFIED COMMUNICATION CONTENT

(71) Applicants: Manvi Sanjeeva, Bangalore Karnataka (IN); Venugopal K. Srinivasmurthy, Bangalore (IN); Frederic Huve, Villard Bonnot (FR)

(72) Inventors: Manvi Sanjeeva, Bangalore Karnataka (IN); Venugopal K. Srinivasmurthy, Bangalore (IN); Frederic Huve, Villard Bonnot (FR)

(21) Appl. No.: 14/116,129

(22) PCT Filed: Oct. 24, 2011
(86) PCT No.: PCT/US2011/057507

§ 371 Date: Nov. 6, 2013

(30) Foreign Application Priority Data
Jun. 29, 2011 (IN) 2206/CHE/2011

(51) Int. Cl. G06F 17/30; G10L 13/00

(52) U.S. Cl. CPC G06F 17/30979; G10L 13/00
USPC 704/260; 707/769

(57) ABSTRACT

Example embodiments disclosed herein relate to using intelligence within unified communication content to facilitate, services. A semantic store including unified communication content is queried. Then, results of the query are determined.

### BACKGROUND

Service providers are challenged to deliver quality and value to consumers, for example by providing unified communication and/or messaging services. Unified communications integrate real-time communication services such as instant messaging sessions, telephony, video conferencing, or the like with non-real-time communication services, such as unified messaging (e.g., integrated voicemail, email, etc.). Thus, unified communications allow a user to send a message on one medium and receive the same communication in another medium. For example, when a user leaves a voicemail message for another user, the voicemail message can be converted into another medium, for example, an email for viewing by the other user.

### BRIEF DESCRIPTION OF THE DRAWINGS

The following detailed description references the drawings, wherein:

FIG. 1 is a block diagram of a system for using unified communication content to provide services, according to one example;

FIGS. 2A and 2B are block diagrams of services platforms capable of using unified communication content to provide services, according to various examples;

FIG. 3 is a flowchart of a method for searching a semantic store bas on voice based communication information, according to one example;

FIG. 4 is a flowchart of a method for using unified communication information to provide a service, according to one example; and

FIG. 5 is a block diagram of a computing device capable, of providing services using unified communication content, according to one example.

### DETAILED DESCRIPTION

Unified communications (UC) is an emerging trend in providing services. For example, many enterprise businesses as well as telecom service provider networks have embraced the utilization of unified communication. Integration of unified communication enables communication and sharing of communication content without client barriers. As such, unified communication allows for a user to receive a message via a first medium and access it through another medium. For example, a voicemail message meant to be received via a telephone client can be received at an email client.

Unified communication treats communication data as an unintelligent payload. As such, intelligence present within the communication data is not harnessed by unified communication servers. However, processing communication data of unified communication can lead to a more personalized user experience in providing services to users. Thus, richer user experience and/or productivity can be achieved when communication is unified at a data level across various types of content.

Accordingly, various embodiments disclosed herein elate to harnessing intelligence in unified communication content to provide services. In certain embodiments, unified communication content is the payload of unified communication (e.g., a voice mail message, the payload of a text message, etc.). Semantic data modeling and/or semantic web technologies can be used to generate a rich user experience for users. For example, the speech data from a multimedia UC can be subject to speech recognition processes to generate transcripts. Transcripts produced using such recognition techniques can be subject to semantic information extraction. These transcripts can then be used to form semantic queries over a database to provide a context sensitive user experience. As such, the information within the multimedia UC can be used to customize user experience.

In other examples, transcripts can be processed and become part of the database. The database can be, for example, a semantic repository. The semantic repository can be generated based on a Resource Description Framework (RDF) modeling scheme. Further, the semantic repository can be built on various types of information sources. For example, the semantic repository can include source information from blogs, unified communication, wiki, an enterprise knowledge base, other databases, or combinations thereof. Moreover, some information of the semantic repository can be tied to a user (e.g., one or more unified communication databases) while other information included in the semantic repository can be designated as public information. As such, some of the information may be used in the customization of a particular user's content while other information may be available to customize any user's content.

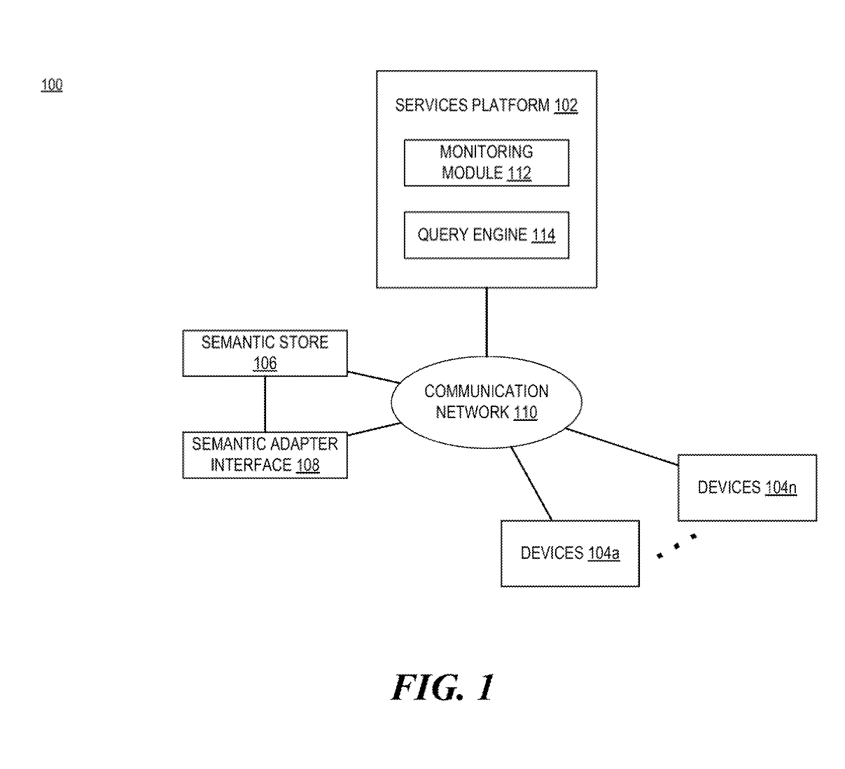

Referring now to the drawings, FIG. 1 is a block diagram of a system for using unified communication content to provide services, according to one example The system 100 can include a services platform 102 that communicates with devices 104a-104n, a semantic store 106, a semantic adapter interface 108, or a combination thereof via a communication network 110. In certain examples, the services platform 102, the devices 104a-104n, the semantic store 106, and/or the semantic adapter interface 108 are implemented as computing devices, such as servers, client computers, desktop computers, mobile computers, etc. In other embodiments, the devices 104a-104n can include special purpose machines. In certain examples, devices 104a-104n can include enterprise devices (e.g., workstations. Internet Protocol (IP) telephones, etc.), mobile devices (e,g., cellular telephones, tablets, slate computing devices, etc.), telephony devices (e,g., IP telephones, video conferencing, etc.), or the like.

The services platform 102, devices 104, semantic store 106, semantic adapter interface 108, or a combination thereof can be implemented via a processing element, memory, ardor other components. The services platform 102 can receive requests for services from one or more of the devices 104 via the communication network 110. Services can include, for example, providing unified communication services, call center services, entertainment services, messaging services, information services, voice response services, etc.

Services provided by the services platform 102 can use information stored at the semantic store 106. The semantic store 106 can include unified communication information generated from multiple unified communication methods. Further, the semantic store 106 can include information from other locations, such as internet websites, an enterprise knowledge base, and other databases. Examples of internet websites include blogs and wiki. Moreover, the semantic store 106 can be implemented in the form of storage attached to a computing device.

The semantic store 106 can be stored using a semantic RDF model. In certain examples, the RDF model is a family of World Wide Web Consortium (W3C) specifications used for conceptual description or modeling of information that is implemented in web resources using a variety of syntax formats. Other models can be used to generate the semantic store 106 as well such as class diagrams or entity-relationship models. The RDF model is based on the idea of making statements about resources in the form of subject-predicate-object expressions. In RDF terminology, subject-predicate-object expressions are known as triples. The subject can represent a resource, and the predicate can represent a trait or aspect of the resource, and can express a relationship between the subject and the object. Various types of formats can be used to express the triples. It is further contemplated that the approaches described herein can be used with non-semantic storage to provide one or more services.

The semantic adapter interface 108 can be used to process information to generate data structures stored in the semantic store 106. The semantic adapter interface 108 can be implemented using a processor with access to the semantic store 106 and a connection to an information source (e.g., via The communication network 110). The semantic adapter interface 108 can receive content from various sources, for example, instant messaging, email, blogs, unified communication, or the like. The semantic adapter interface 108 then processes the content into a format compatible with the semantic store 106. For example, the information can be transformed or virtualized into RDF format. Further, other ontology can be used to generate the semantic store 106. Moreover, different ontology can be used to generate different parts of the semantic store 106. For example, a first ontology can be used to process UC such as email, presence services, messaging services, call services, etc. while a second ontology, for example, Semantically Interlinked Online Communities (SIOC) ontology can be used to process other user generated content like wiki, blogs, etc.

As noted above, the semantic store 106 can be generated by information received at the semantic adapter interface 108. In one example, the semantic adapter interface 108 receives information from one or more sources (e.g., devices 104a-104n, wiki, etc.). Examples of the sources are instant messaging sources, electronic mail sources, and web based media. The semantic adapter interface 108 then converts the received information into the RDF model or another type of ontology. The semantic store 106 is then updated with the converted information. The semantic store building/update process can run continuously, periodically, based on a trigger, or the like.

In some examples, the services platform 102 provides unified communication services to devices 104. A device 104 sends unified communication or other information (e.g., a request) to the services platform 102. A monitoring module 112 of the services platform monitors incoming information. Thus, the monitoring module 112 monitors one or more unified communications associated with the services platform 102. The monitoring can be accomplished by transforming content received as unified communication into a usable format, if necessary, and then processing the UC data. For example, voice-based UC content can be processed into a transcript that can be monitored. The transcript can be monitored, for example, for one or more keywords or key phrases. The keywords and/or key phrases can be extracted using various processes, for example, by using the key phrase extraction algorithm (KEA). The KEA can be processed by one or more processors and, in certain examples, the use of the approach can be trained (e.g., using manual input).

When such a keyword or phrase is found, a query engine 114 determines search criteria based on the UC data. As previously noted, the UC data can be processed into the transcript, the keywords and/or the key phrases. The search criteria can include one or more of the keywords and/or key phrases. Moreover, the search criteria can be determined using one or more words that occur before or after a keyword or phrase. For example, a key phrase of “my name is” followed by “NAME' can use “NAME” as criteria to search the semantic store 106 for content associated with “NAME.” Further, in certain examples, the semantic store 106 can be indexed with a name field that can be used to search or filter information that is searched. As such, the semantic information can be filtered based on the search criteria and other searches can be executed on the unfiltered information. As such, the search criteria can be used by the query engine 114 to query the semantic store 106 to retrieve search results. Although the previous example is directed towards the monitoring of UC data, other types of data and/or communications can be monitored to generate the search criteria. Further, the search criteria can also be generated in response to other scenarios, such as an explicit request.

The communication network 110 can use wired communications, wireless communications, or combinations thereof. Further, the communication network 110 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 110 can be in the form of a direct network link between devices. Various communications structures and infrastructure can be used to implement the communication network(s).

By way of example, the services platform 102, devices 104, semantic store 106, semantic adapter interface 108, or a combination thereof communicate with each other and other components with access to the communication network 110 via a communication protocol or multiple protocols. A protocol can be a set of rules that defines how nodes of the communication network 110 interact with other nodes. Further, communications between network nodes can be implemented by exchanging discrete packets of data or sending messages. Packets can include header information associated with a protocol (e.g., information on the location of the network node(s) to contact) as well as payload information. A program or application executing on, the services platform 102, any of the devices 104, the semantic store 106, the semantic adapter interface 108, or a combination thereof can use one or more layers of communication to use the messages.

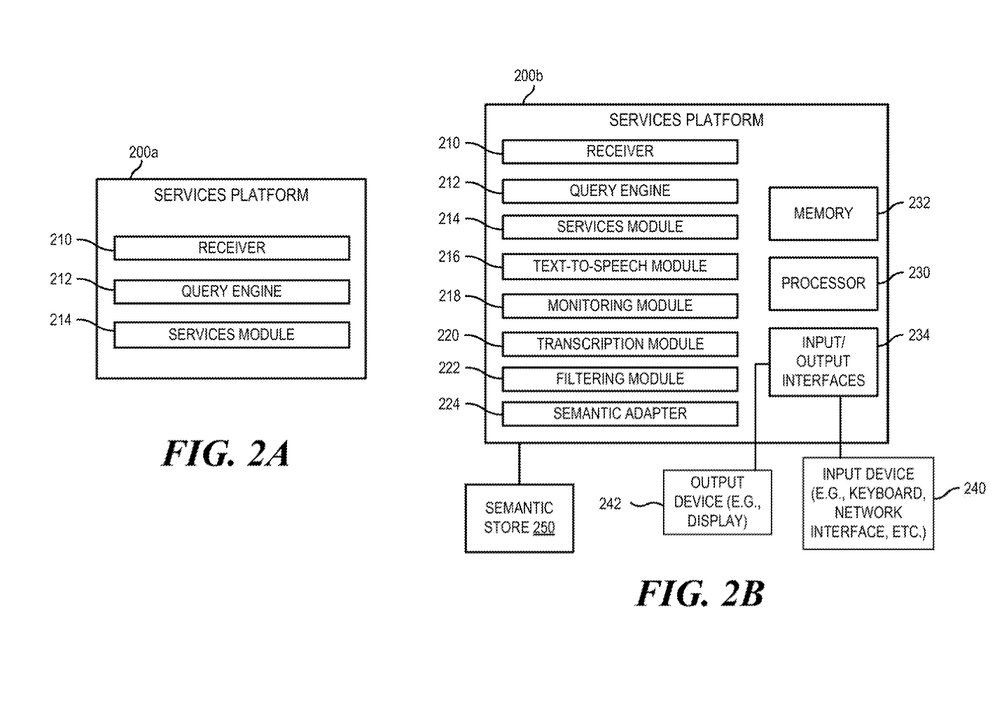

FIGS. 2A and 2B are block diagrams of services platforms capable of using unified communication content to provide services, according to various examples. Services platforms 200a, 200b include components that can be used to customize a user experience based on unified communication information. The respective services platforms 200a, 200b may be a notebook computer, a desktop computer, a tablet computing device, a wireless device, a server, a workstation, or any other computing device that is capable of providing services to other devices. The services platform 200a can include a receiver 210 capable of receiving information, such as requests for services to be performed.

Further, the services platform 200a can include modules 212-224, such as a query engine 212 and services module 214. A processor, such as a central processing unit (CPU), a graphics processing unit (GPU), or a microprocessor suitable for retrieval and execution of instructions and/or electronic circuits configured to perform the functionality of any of the modules 212-224. In some embodiments, the services platforms 200a, 200b can include some of the modules (e.g., modules 212-214) as shown in FIG. 2A, the modules (e.g., modules 212-224) shown in FIG. 2B, and/or additional components, such as one or more processors 230, memory 232, or one or more input/output interfaces 234 that can be used to receive input from an input device 240 or transmit output to an output device 242.

In one embodiment, the receiver 210 receives a request for a service. The service can be associated with a user, with unified communication, with other identifying material, etc. Further, the service can be associated with a user based on an account (e.g., email, internet based account, phone number, etc.) sending the request and: or receiving the service based on the request. The service can be, for example, an audible conversion of a text based unified communication. In certain examples, the text based unified communication can include an instant message, an electronic mail message, or a text message. The service can be a live service, for example, the reading out of an email during a telephone communication. Further, the service can be a non-live service, for example, conversion of the email to a podcast and then transmitting the podcast to a device of a user making the request. Other services, for example, providing a smart call center unified communication information associated with the user can be provided.

To provide the service, the services platform 200 can use a query engine 212 to query a semantic store 250 including unified communication information associated with the use to generate customization information. The customization information can be used to customize the service based on the user. The services module 214 then uses the customization information to provide the service.

In the context of a text-to-speech service, a text-based communication can be parsed to determine context associated with the communication. For example, the originator, the subject, any email flags, the message body, or the like can be parsed. This context information can be used to generate the query to the semantic store 250. The query engine 212 then queries the semantic store 250 for the customization information that can be used to customize the audible conversion process. As previously noted, the semantic store 250 can include unified communication information as well as information from other locations, such as blogs, wiki, enterprise knowledge bases, other databases, or the like. When making the query, the context information can be used to determine one of more portions of the semantic store 250 to query. For example, a database associated with the originator, subject, or other keywords or phrases can be queried based on the context information.

Customization information can include, for example, information that can be used to produce proper sounding audio in the message body or other parts of the text based unified communication being translated to speech. For example, the customization information can include association of one or more abbreviations with grammatical speech information, an association of one or more aliases with grammatical speech information, or the like. The grammatical speech information can be taken from, for example, other unified communication.

In one example, aliases (e.g., an account name) can be associated with a proper name within one or more unified communications. The semantic store. 250 can be updated with such an association. This can occur, for example, if an originator of a communication associated with the alias signs his or her name during a communication or communicates the information with certain key words, for example, the key phrase “I am” followed by “NAME” can be used to associate an alias (e.g., phone number) sending the unified communication with “NAME.”

The text-to-speech module 216 can convert the textual information to audio information based on the customization information. Moreover, the text-to-speech module 216 can be implemented using one or more speech synthesis technology. Further, the text-to-speech module 216 can convert the textual information into written out words. This can include, for example, converting aliases, abbreviations, numbers, etc. into written out words. These words can be determined based on the customization information and may be specific to the user and/or user account. Then, phonetic transcriptions can be assigned to each word and pauses can be used to divide words, sentences, paragraphs, etc. The phonetic transcriptions can then be converted into sound. In certain scenarios, if customization information based on unified communication of the user includes voice information, the audio conversion can be tuned to sound like the user (e.g., by changing pitch, contour, phoneme durations, etc.).

In certain scenarios, a monitoring module 218 is used to determine whether a request for a service has been made. For example, in the context of a call center service, a user can communicate with a call center agent. The call center agent may have a computing device providing the call center agent a service that can help the agent perform the agents duties. The services platform 200b can monitor the communications in real time, for example, by generating a real-time transcript via a transcription module 220. As such the monitoring module 218, the transcription module 220, or a combination thereof can include speech recognition capabilities. The services module 214 can query the semantic store 250 via the query engine 212 to provide the call center agent with real time help based on context of the real-time transcript. For example, if the context of the real-time communication involves a particular situation or problem the user is having, a query focused on that situation or problem can be performed and the results can he used to provide useful information to the call center agent.

In one example, the user may have used unified communications in the past to communicate with an entity associated with the call center agent. The unified communications may provide information that allows the call center agent to determine an appropriate call of action. In another example, the service can provide the call center agent with information about a product or service that the call center may be able to provide to the user. This may be determined, for example, based on a query of the user's past activities based on the unified communication information. As such, the context of a conversation can be used to determine search criteria. Further, the search results, the semantic store 250, a combination thereof, etc. can be filtered via the filtering module 222. In one example, the use of the semantic store 250 is unfiltered, in which case the unified communications of other users are used. In another example, the use of the semantic store 250 is filtered by the filtering module 222. The filtering can be accomplished, for example, by determining a user and/or a set of user accounts (e.g., a particular user account, a particular set of accounts based on criteria such as location or account type, etc.) and either filtering the available information to query from the semantic store 250 or filtering the returned results.

In another example, the service provided includes notification of subscription information. The subscription can be tuned to provide information about a subject. In one example, a manager at a business may desire to subscribe to the manager's unified communications and/or unified communications of the managers subordinates. As such, when the subject is part of a unified communication, the manager can be notified. In this example, the manager can send a subscription request to the receiver 210 for the service. The services module 214 can query the semantic store 250 via the query engine 212 periodically or based on a request for the customization information including an identifier of the particular unified communication. Then, the services module 214 can provide a notification to the manager via a device of the manager. In certain scenarios, the notification includes a summary or identifier of the unified communication. In other scenarios, the notification includes additional information, such as information about the subject including multiple unified communications and/or other information sources of the semantic store 250. As such, a briefcase about the subject or other subscription criteria can be generated based on the semantic store 250 and stored at a device of the manager. In this example, a manager is used; however, it is contemplated that other users may subscribe to information in the semantic store 250.

In yet another example, the service can be to provide information about subject based on a received unified communication. The information and/or subject can be determined based on an analysis of the unified communication. This can be useful to help a user understand a unified communication based on previous communications. Thus, if the user is sent a voicemail unified communication and chooses to receive it as an email, the information can be parsed and a service can provide additional information to understand the communication. For example, the user can receive a unified communication including words that the user does not understand; the user may receive an associated dictionary as a service. Such a dictionary may include unified communication from other users. In certain examples, the filtering module 222 can filter the dictionary of the based on the user. For example, the source of information to generate the dictionary can be filtered to come from unified communications associated with the user (e.g., with the user as a party to the communication, a group in which the user is a member, etc.).

As noted above, a semantic adapter 224 can be used to generate and/or update the semantic store 250. In certain examples, multiple semantic adapters 224 can be used. As such, a semantic adapter 224 included at the services platform 200b can be used to convert received information into ontology (e.g., the RDF model) and update the semantic store 250.

Each of the modules 212-224 may include, for example, hardware devices including electronic circuitry for implementing the functionality described. In addition or as an alternative, each module 212-224 may be implemented as a series of instructions encoded on a machine-readable storage medium of services platform 200 and executable by processor 230. It should be noted that in some embodiments, some modules are implemented as hardware devices, while other modules are implemented as executable instructions. Moreover, in some embodiments, portions of the services platform 200 can be separated and/or performed on different devices.

In some emotes, input devices 240, such as a keyboard, a touch interface, a mouse, a microphone, etc. can be used to receive input from an environment surrounding the services platform 200b. Further, an output device 242, such as a display can be used to present information to users. Examples of output devices include speakers, display devices, amplifiers, etc. Moreover, in certain embodiments, some components can be used to implement functionality of other components described herein.

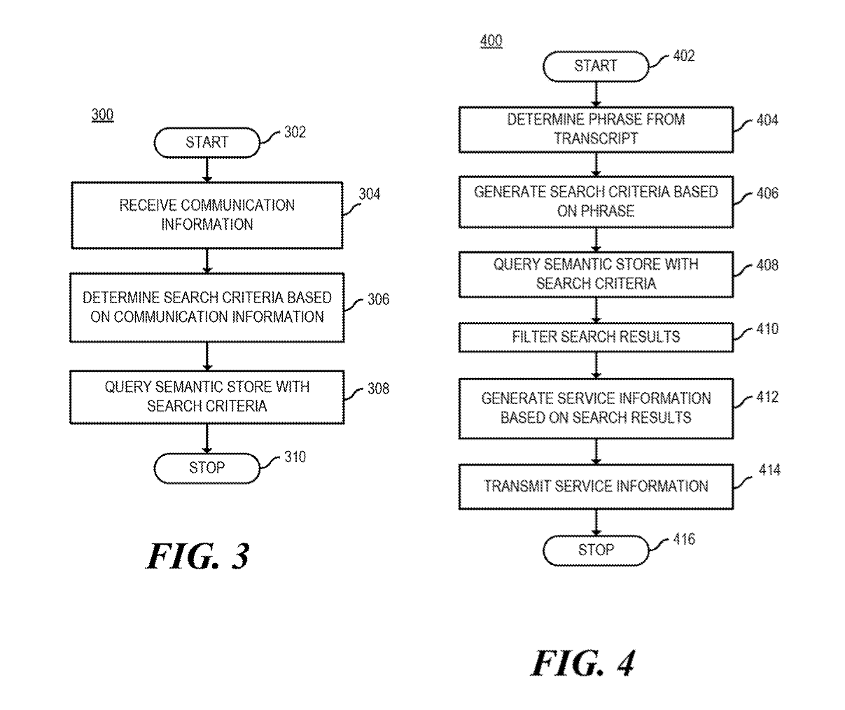

FIG. 3 is a flowchart of a method for searching a semantic store based on voice based communication information, according to one example. Although execution of method 300 is described below with reference to services platform 200b, other suitable components for execution of method 300 can be used (e.g., services platform 200a, computing device 500). Additionally, the components for executing the method 300 may be spread among, multiple devices. Method 300 may be implemented in the form of executable instructions stored on a machine-readable storage medium, and or in the form of electronic circuitry.

Method 300 may start at 302 and proceed to 304, where a receiver 210 of a services platform 200b receives communication information. A monitoring module 218 may monitor such communication information to provide one or more services. In certain embodiments, the communication information can be an instant message, email, voice based etc. As such in the case of a voice based communication, the services platform 200b may receive voice based communication from a user entity, for example, a call center or as part of a video conferencing session. Further, in the case of a voice based communication, a transcription module 220 generates a transcript based on the voice based communication information. The transcript can include a conversion of spoken words into text. One or more speech recognition technologies can be used to generate the transcript.

Then, at 306, a services module 214 can use the communication information (e.g., transcript) to determine search criteria. The search criteria can be formulated based on one or more keyswords and/or key phrases recognized in the communication information (e.g., based on the transcript, on messaging information, etc.). For example, in the case of a call center, one or more topics that a customer is conversing about with a call center agent can be used to generate the search criteria. Further, the search criteria may be focused based on one or more other keywords and/or phrases. For example, the search criteria can be focused to a location of the customer. Presentation of information to the call center agent can be based on what service is provided to the call center agent.

At 308, a query engine 212 queries a semantic store 250 including unified communication content with the search criteria to generate search results. As detailed above, the semantic store 250 can be based on a resource description framework data model. The unified communication content stored in the semantic store 250 can include content from multiple unified communications sessions. Moreover, the unified communications sessions can include information from a voice transcript, an instant message, an electronic mail message, a text message, or a combination thereof. As noted previously, a semantic adapter can be used to convert the information from unified communications sessions into the semantic store 250. Also, the semantic store 250 can include information from other sources, for example, wild sources, web site sources, dictionaries, encyclopedias, etc. Then, at 310, the method 300 stops. The services platform 200b can provide services based on the search results.

In one example, a service provided is information related to a question raised by the customer during a call to a call center. In this scenario, the voice based communication can be considered the call. A key phrase, for example, the question, can be used to query the semantic database for results. Further, because unified content is used, the content can be personalized for the customer. The search results can be used to generate information that can be useful to answer the question and or can include an answer to the question. The information and/or answer can then be transmitted to the call center. At this time the information can be presented to a user to provide the answer to the customer.

FIG. 4 is a flowchart of a method for using unified communication information to provide a service, according to one example. Although execution of method 400 is described below with reference to services platform 200b, other suitable components for execution of method 400 can used (e.g., services platform 200a, computing device 500). Additionally, the components for executing the method 400 may be spread among multiple devices. Method 400 may be implemented in the form of executable instructions stored on a machine-readable storage medium, and/or in the form of electronic circuitry.

The services platform 200b can receive a communication or request that causes the services platform 200b to perform a service for a user, for example, via a user device. The communication or request can include a textual transcript. In certain scenarios, the communication or request can include audio information that can be converted to the textual transcript, a string of instant messages, one or more emails, or a combination thereof. The transcript can be used to provide the service.

The method 400 can start at 402 and proceed to 404, where the services platform 200b determines a phrase from the transcript based on a keyphrase index. In certain examples, a keyphrase index is a system to facilitate the finding of information that uses key phrases. Further, key phrases, in some embodiments, are a group of words that can be used to obtain to specific information in a search query. For example, a key phrase “I am” can be used in parsing of the transcript. When the words “I am” are found, a particular query can be formed based on the keyphrase. For example, the words “I am” followed by “John Smith” can be used to formulate a search. Phrases such as “I am” can be stored in the keyphase index. Further, the phrases can be respectively associated with a function or application, for example, the recognition, of a key phrase can be used to modify and/or initiate use of a query.

At 406, the query engine 212 generates search criteria based on the phrase. The search criteria can be based on other information, for example, other key phrases, one or more selected services, context information, or the like. Further, the search criteria based on the phrase can include semantic relevance techniques. For example, the search criteria can include synonyms or thresholds based on the phrase (e.g., search criteria including portions of the phrase and/or portions of a keyword of the phrase). As previously noted, the search criteria can be based on a context determined from user information. For example, the search criteria may filter databases searched based on the context. Then, at 408, the query engine 212 queries a semantic store 250 with the search criteria to produce results. As noted previously, the semantic store 250 can include information generated from unified communications.

At 410, the search results cyan be filtered by a filtering module 222. In one scenario, the results are filtered using user information. The user information can be determined, for example, from the transcript or another manner (e.g., in a call center example, the call center agent may identify the customer user to the services platform 200b). The user information can identify, for example, one 04 more groups of information stored in the semantic store 250 (e.g., databases or information with a corresponding field) that may be relevant based on the user information. For example, unified communication information may be tagged with information (e.g., parties to a communication, a group associated with the communication etc.) that can be searched for or used to select the unified communication information. As such, relevant unified communication information can be used in providing the service.

The services module 214 then provides a service based on the search results. As such, the services module 214 generates service information based on the search results (at 412). In one scenario, the service can be to provide groups of unified communication or other information in the semantic store as a briefcase (e.g., as a set of emails or messages). Further, other options can be used, for example, the read-out service can be provided for the briefcase. As noted previously, the read-out service may be customized based on the search results. Moreover, in certain scenarios, the service information can be generated in the form of a notification. The notification can include information related to the phrase based on the search results. The notification can further include information that answers a question associated with the phrase and/or a sales item related to the phrase. At 414, the service information is transmitted to the user. As such, a client device of the user can receive the service information (e.g., a notification) to provide the service. Then, at 416, the method 400 stops.

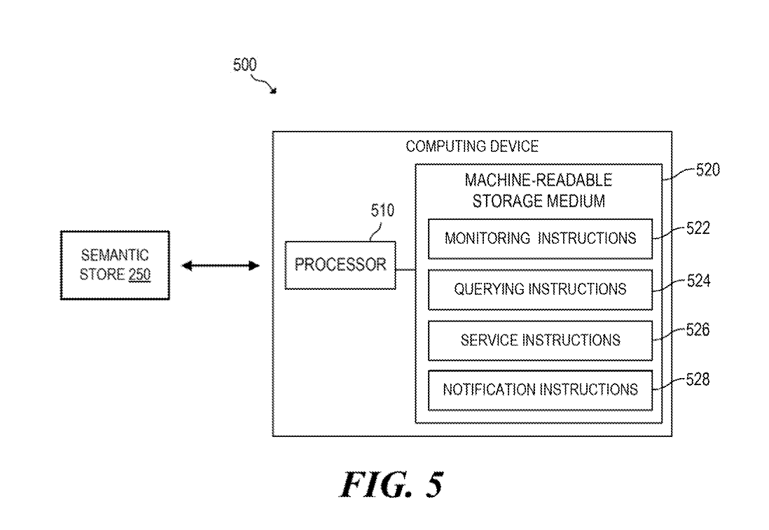

FIG. 5 is a block diagram of a computing device capable of providing services using unified communication content, according to one example. The computing device 500 includes, for example, a processor 510, and a machine-readable storage medium 520 including instructions 522, 524, 526, 528 for providing services using a semantic store. Computing device 500 may max be, for example; a notebook computer, a server, a workstation, or any other computing device.

Processor 510 may be, at least one central processing unit, at least one semiconductor-based microprocessor, at least one graphics processing unit, other hardware devices suitable for retrieval and execution of instructions stored in machine-readable storage medium 520, or combinations thereof. For example, the processor 510 may include multiple cores on a chip, include multiple cores across multiple chips, multiple cores across multiple devices (e.g., if the computing device 500 includes multiple node devices), or combinations thereof. Processor 510 may fetch, decode, and execute instructions 522-528 to implement methods 300, 400 as well as other processes. As an alternative or in addition to retrieving and executing instructions, processor 510 may include at least one integrated circuit (IC), other control logic, other electronic circuits, or combinations thereof that include a number of electronic components for performing the functionality of instructions 522-528.

Machine-readable storage medium 520 may be any electronic, magnetic, optical, or other physical storage device that contains or stores executable instructions. Thus, machine-readable storage medium may be for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail below, machine-readable storage medium 520 may be encoded with a series of executable instructions for implementing services using a semantic store including, for example, unified communication content. The processor 510 and machine-readable storage medium 520 combination can also be used for other devices client devices such as a call center computer, email device, phone, etc.).

Monitoring instructions 522 can be used to cause the processor to monitor and/or process information received via a receiver. The monitoring instructions 522 can be used to determine whether a service should be implemented for one or more users. This can be based on an explicit request (e.g., a user requesting a service explicitly) or an implicit request (e.g., monitoring of a telephone call or a video conference to determine whether a service should be provided).

Once the monitoring instructions 522 determine that a service is to be provided, the querying instructions 524 are executed to help provide the service. The querying instructions 524 can formulate a query (e.g., based on context, an explicit request, or the like). The query can be performed on a database that includes unified communication content, such as the semantic store 250. The content can include information that is within the unified communication. Once the query is complete, the service instructions 526 can be executed by the processor 510 to provide the service.

In certain scenarios, the service provides one or more notifications to one or more users of devices via the notification instructions 528. The notification instructions 528 can be used to generate a notification and send the notification to one of the devices. In certain examples, the notification service may be implemented after reception of a request by subscribing the user to particular information. For example, a notification can be provided to the user if it is determined that the contents of a new unified communication (e.g., a unified communication added to the semantic store 250) are related to the information the user is subscribing to. In one example, the user can be the manager of a group with access to messages of the group. As such, when the unified communication is processed, the user can be notified of the existence of the unified communication within the user's group. The notification can include a pointer to the location of the unified communication and/or additional information, such as a summary, tags, the content, or the like.

With the above approaches, content stored in the body of unified communications can be used to provide services. The intelligence stored in the unified communications is harnessed to generate a database. In some scenarios, the database can be a semantic repository, for example, a repository based on RDF modeling. The repository can include information from other sources as well As such, a robust database can be used to provide services to users.

What is claimed is:

1. A method comprising:
receiving communication information;
determining search criteria based on the communication information; and querying a semantic store including unified communication content with the search criteria to generate search results.

2. The method of claim 1, further comprising:
determining a phrase from the communication information based on a keyphrase index,
wherein the search criteria is based on the phrase.

3. The method of claim 2, further comprising:
generating a notification of information related to the phrase.

4. The method of claim 1, wherein the semantic store is based resource description framework data model.

5. The method of claim 1, wherein the unified communication content includes content from a plurality of unified communication sessions.

6. The method of claim 5, wherein the semantic store includes information from at least one of: a voice transcript, an instant message, an electronic mail message, blog content, and wiki content.

7. The method of claim 1, further comprising:
determining a context based on user information,
wherein the search criteria is based on the context.

8. The method of claim 7, further comprising:
filtering the search results based on the user information.

9. The method of claim 1, the method further comprising:
generating service information based on the search results; and transmitting the service information to a user.

10. A services platform comprising:
a receiver to receive a request for a service associated with a user;
a query engine to query a semantic store including unified communication content associated with the user to generate customization information; and
a services module to provide the service based on the customization information.

11. The services platform of claim 10, wherein the service includes an audible conversion of textual information, the services platform further comprising:
a text-to-speech module to convert the textual information to audio information based on the customization information.

12. The services platform of claim 11, wherein the customization information includes at least one of: association of an abbreviation included in the text with grammatical speech information, and association of an alias included in the text with the grammatical speech information.

13. A system comprising:
a semantic store including unified communication content generated from a plurality of unified communication methods;
a services platform including:
a monitoring module to monitor one or more unified communications; and
a query engine to determine search criteria based on the one or more unified communications,
wherein the query engine is further caused to query the semantic store based on the search criteria to retrieve search results.

14. The system of claim 13, further comprising:
a semantic adapter interface,
wherein the semantic adapter interface caused to receive information from a plurality of sources,
wherein the semantic adapter interface is caused to convert the received information into a resource description framework model, and
wherein the semantic adapter interface is caused to update the semantic store with the converted information.

15. The system of claim 13, wherein the sources include at least one of: an instant messaging source, an electronic mail source, and web based media.
